(19) United States
(12) Patent Application Publication
(10) Pub. No.: US 2026/0122561 A1
(43) Pub. Date: Apr. 30, 2026

(54) A SYSTEM IN A TELECOMMUNICATIONS NETWORK AND A METHOD OF RETROFITTING THE SAME

(71) Applicant: British Telecommunications Public Limited Company, London (GB)

(72) Inventors: Alexander PARKER, London (GB); Darren COLE, London (GB)

(21) Appl. No.: 19/163,673

(22) PCT Filed: Feb. 6, 2024
(86) PCT No.: PCT/EP2024/052933

§ 371 Date: Sep. 9, 2025

(30) Foreign Application Priority Data
Mar. 14, 2023 (EP) 23161752.3

(51) Int. Cl. H04W 52/02; H02J 3/00; H04W 88/08

(52) U.S. Cl. CPC H04W 52/0206; H02J 3/00; H04W 88/085

(57) ABSTRACT

This invention provides a method of retrofitting a system in a telecommunications network, the system comprising a network equipment, a power supply unit, and a power supply circuit, wherein the power supply circuit is provided between a first output of a plurality of outputs of the power supply unit and the network equipment, the method comprising the steps of: modifying the power supply circuit to comprise a switching unit configured to switch between an open state and a closed state; modifying the system to include a control circuit, wherein the control circuit comprises a controller having a power supply requirement; powering the control circuit by: connecting the control circuit to a second output of the plurality of outputs of the power supply unit, and converting a power supply of the second output of the plurality of outputs of the power supply unit to meet the power supply requirement of the controller; isolating the control circuit and power supply circuit using an isolator; and configuring the controller to, in response to a command to control the switching unit, control the switching unit to cause the controlled switching unit to switch between the open state and closed state.

### PRIORITY CLAIM

The present application is a National Phase Entry of PCT Application No. PCT/EP2024/052933, filed Feb. 6, 2024, which claims priority from EP Application No. 23161752.3, filed Mar. 14, 2023, each of which is hereby fully incorporated herein by reference.

### TECHNICAL FIELD DISCLOSURE

The present disclosure relates to a system in a telecommunications network and a method of retrofitting a system in a telecommunications network.

### BACKGROUND

A telecommunications network typically comprises network equipment which consumes energy during operation. An overall energy consumption of a telecommunications network is a sum of the energy consumption of all network equipment in the telecommunications network. If the telecommunications network includes a mass deployment of network equipment (e.g. thousands, tens of thousands or hundreds of thousands of network equipment) then the overall energy consumption may be extremely high. It is desirable to reduce this overall energy consumption.

One method of reducing the overall energy consumption is to utilize an optional energy saving mode at one or more network equipment. The energy saving mode reduces the amount of energy consumed by the network equipment by, for example, reducing its transmission power and/or processing capabilities. An energy saving mode has been standardized in wireless wide area telecommunications, such as by the 3^{rd} Generation Partnership Project (3GPP).

### SUMMARY DISCLOSURE

According to a first aspect of the disclosure, there is provided a method of retrofitting a system in a telecommunications network, the system comprising a network equipment, a power supply unit, and a power supply circuit, wherein the power supply circuit is provided between a first output of a plurality of outputs of the power supply unit and the network equipment, the method comprising: modifying the power supply circuit to comprise a switching unit configured to switch between an open state and a closed state; modifying the system to include a control circuit, wherein the control circuit comprises a controller having a power supply requirement; powering the control circuit by: connecting the control circuit to a second output of the plurality of outputs of the power supply unit, and converting a power supply of the second output of the plurality of outputs of the power supply unit to meet the power supply requirement of the controller; isolating the control circuit and power supply circuit using an isolator; and configuring the controller to, in response to a command to control the switching unit, control the switching unit to cause the controlled switching unit to switch between the open state and closed state.

The system may comprise a plurality of network equipment and a plurality of power supply circuits, wherein each power supply circuit is provided between a respective output of the plurality of outputs of the power supply unit and a respective network equipment of the plurality of network equipment, and the method may further comprise: modifying each power supply circuit to comprise a respective switching unit configured to switch between an open state and a closed state; isolating the control circuit and each power supply circuit of the plurality of power supply circuits using a respective isolator; and configuring the controller to, in response to a command to control one or more of the plurality of switching units, selectively control the one or more of the plurality of switching units in the command to cause the controlled one or more of the plurality of switching units to switch between the open state and the closed state.

The method may further comprise: connecting the controller to a remote computing device, wherein the controller is configured to receive, from the remote computing device, one or more of: the command to control the switching unit or the one or more of the plurality of switching units, an instruction to update command generation logic, and an instruction to cease operation.

According to a second aspect of the disclosure, there is provided a method of retrofitting a plurality of systems, each system being retrofitted according to the method of the first aspect of the disclosure, wherein the respective controller of each system may be configured, in response to the command to control the respective switching unit or one or more of the plurality of respective switching units, to: control the respective switching unit to cause the controlled respective switching unit to switch between the open state and closed state, control the first and second switches of the respective switching unit to cause the activated first and second switches of the respective switching unit to switch between the open state and closed state, selectively control the one or more of the plurality of respective switching units in the command to cause the activated one or more of the plurality of respective switching units to switch between the open and closed state, or selectively control the first and second switches of the one or more of the plurality of respective switching units in the command to cause the activated first and second switches of the one or more of the plurality of respective switching units to switch between the open state and the closed state.

The method may further comprise: connecting each respective controller of the plurality of systems to a remote computing device, wherein each respective controller is configured to receive, from the remote computing device, one or more of: the command to control the respective switching unit or the one or more of the plurality of respective switching units, an instruction to update command generation logic, and an instruction to cease operation.

According to a third aspect of the disclosure, there is provided a system in a telecommunications network, the system comprising: a network equipment; a power supply unit; a power supply circuit, wherein the power supply circuit is provided between a first output of a plurality of outputs of the power supply unit and the network equipment, the power supply circuit comprising a switching unit configured to switch between an open state and a closed state; a control circuit comprising a controller having a power supply requirement, wherein the control circuit is connected to a second output of the plurality of outputs of the power supply; a converter for converting the power supply of the second output of the plurality of outputs of the power supply unit to meet the power supply requirement of the control circuit; and an isolator configured to isolate the control circuit and the power supply circuit, wherein, in response to a command to control the switching unit, the controller controls the switching unit causing the controlled switching unit to switch between the open state and closed state.

The switching unit may comprise a first switch and a second switch, the first and second switches each being configured to switch between an open state and a closed state, and the controller may be configured to, in response to the command to control the switching unit, control the first and second switches of the switching unit to cause the controlled first and second switches of the switching unit to switch between the open and closed state.

The network equipment may be one of a plurality of network equipment, the power supply circuit may be one of a plurality of power supply circuits, wherein each power supply circuit may be provided between a respective output of the plurality of outputs of the power supply unit and a respective network equipment of the plurality of network equipment, each power supply circuit comprising a respective switching unit, the isolator may be one of a plurality of isolators, each isolating the control circuit from a respective power supply circuit of the plurality of power supply circuits, wherein, in response to the command to control one or more of the plurality of switching units, the controller may selectively control the one or more of the plurality of switching units in the command causing the controlled one or more of the plurality of switching units to switch between the open state and closed state.

Each respective switching unit may comprise a first switch and a second switch, the first and second switches of each respective switching unit being configured to switch between an open state and a closed state, and configuring the controller to, in response to the command to control one or more of the plurality of switching units, selectively control the first and second switches of the one or more of the plurality of switching units in the command to cause the controlled first and second switches of the one or more of the plurality of switching units to switch between the open state and closed state.

The controller may be configured to receive a message including one or more of: the command to control the switching unit or the one or more of the plurality of switching units, an instruction to update command generation logic, and an instruction to cease operation.

According to a fourth aspect of the disclosure, there is provided a plurality of systems, each system of the plurality of systems being a system of the first aspect of the disclosure, wherein, in response to the command to control the respective switching unit or one or more of the plurality of respective switching units, the respective controller of each system may: control the respective switching unit causing the controlled respective switching unit to switch between the open state and closed state, control the first and second switches of the respective switching unit causing the controlled first and second switches of the respective switching unit to switch between the open state and closed state, selectively control the one or more of the plurality of respective switching units in the command causing the controlled one or more of the plurality of respective switching units to switch between the open and closed state, or selectively control the first and second switches of the one or more of the plurality of respective switching units in the command to cause the controlled first and second switches of the one or more of the plurality of respective switching units to switch between the open state and the closed state

Each respective controller of the plurality of systems may be configured to receive a message including one or more of: the command to control the respective switching unit or the one or more of the plurality of respective switching units, an instruction to update command generation logic, and an instruction to cease operation.

The system or plurality of systems may further comprise a remote computing device, wherein the or each respective controller receives the message from the remote computing device.

The or each controller may comprise a human interface device, and the or each controller may receive the message from the human interface device.

The or each controller may comprise a first controller module and a second controller module, wherein: the or each respective first controller module may be configured to receive the message, and the or each respective second controller module may be configured to, in response to the command to control the respective switching unit or one or more of the plurality of respective switching units: control the respective switching unit causing the controlled respective switching unit to switch between the open state and closed state, control the first and second switches of the respective switching unit causing the controlled first and second switches of the respective switching unit to switch between the open state and closed state, selectively control the one or more of the plurality of respective switching units in the command causing the controlled one or more of the plurality of respective switching units to switch between the open and closed state, or selectively control the first and second switches of the one or more of the plurality of respective switching units in the command to cause the controlled first and second switches of the one or more of the plurality of respective switching units to switch between the open state and the closed state.

The or each respective first controller module may comprise a communications interface for receiving the message from the remote computing device and may be configured to cause the or each respective second controller module to implement the command or instruction included in the message.

The or each respective first controller module may comprise a human interface device interface for receiving the message from the human interface device, and the or each first controller module may be configured to cause the second controller module to implement the command or instruction included in the message.

The controller, each respective controller, the second controller module or each respective second controller module may comprise a processor configured to implement logic for generating the command.

The switching unit or each respective switching unit may be in a closed state by default.

The switching unit may comprise one or more of: a contactor, and a relay.

The or each network equipment may be a Remote Radio Unit (RRU or Base Band Unit (BBU).

The controller or each respective controller may be a Single Board Computer (SBC).

The first controller module, each respective first controller module, the second controller module or each respective second controller module may be a Single Board Computer (SBC).

### BRIEF DESCRIPTION OF THE FIGURES

In order that the present disclosure may be better understood, embodiments thereof will now be described, by way of example only, with reference to the accompanying drawings in which:

FIG. 1 is a schematic diagram of a telecommunications network.

FIG. 2 is a schematic diagram of a system, including the telecommunications network of FIG. 1 and energy saving equipment.

FIG. 3 is a flow diagram of a method of retrofitting the telecommunications network with the energy saving equipment.

FIG. 4 is a flow diagram of a method of controlling power supply to one or more network equipment of the telecommunications network.

### DETAILED DESCRIPTION

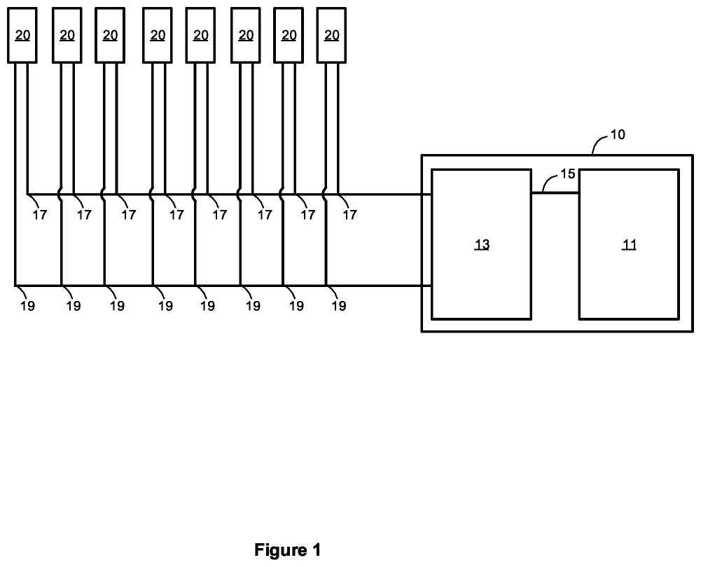

FIG. 1 illustrates a telecommunications network. The telecommunications network includes a power supply unit 10. The power supply unit 10 includes a Direct Current (DC) Distribution Unit (DU) 11, which receives electrical power from an external source (not shown). The power supply unit 10 also includes a first DC to DC converter 13. The DC-DU provides a 54V power supply to the first DC to DC converter 13, via power cable 15, which is converted to a 12V (6-10A) power supply. The first DC to DC converter 13 has a plurality of outputs (in this example, 10 outputs), each providing the 12V power supply and comprising a negative connection 17 and a positive connection 19.

FIG. 1 illustrates a plurality of active networking equipment 20 (in this example, a plurality of Remote Radio Units (RRUs)), each connected to the negative connection 17 and positive connection 19 of an output of the plurality of outputs. A power supply circuit is thus formed for each RRU 20 of the plurality of RRUs 20 between the negative connection 17 and positive connection 19 of an output of the plurality of outputs of the power supply unit 10.

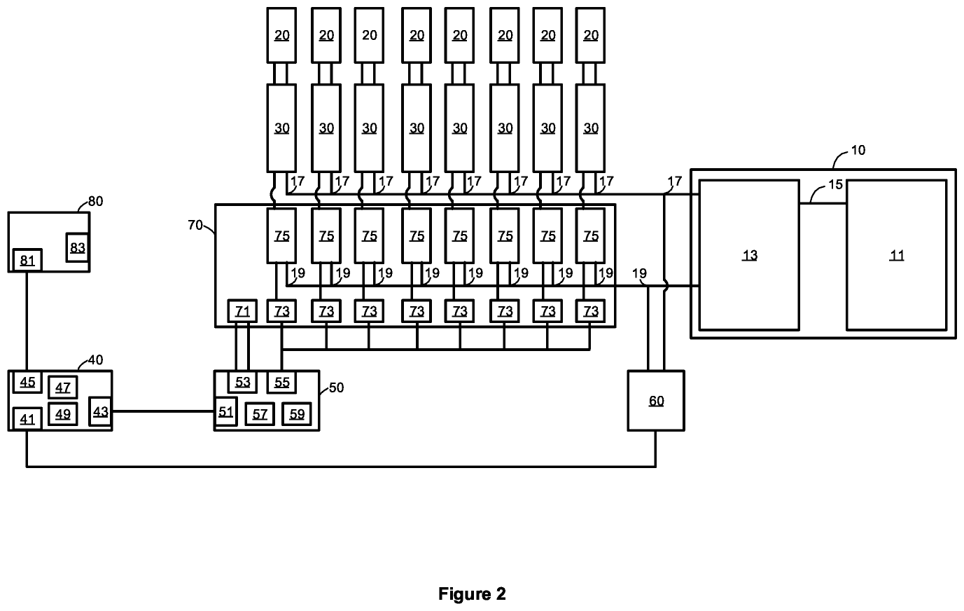

FIG. 2 illustrates the telecommunications network having been retrofitted with energy saving equipment. FIG. 2 illustrates the power supply unit 10 and the plurality of RRUs 20 of the telecommunications network. The energy saving equipment includes a plurality of contactors 30, a first controller module 40, a second controller module 50, a second DC to DC converter 60, a relay board 70 and a remote computing device 80.

A contactor 30 of the plurality of contactors 30 is connected between an RRU 20 of the plurality of RRUs 20 and the negative connection 17 of an output the plurality of outputs of the power supply unit 10. The contactor 30 is therefore part of the RRU's power supply circuit. The contactor 30 may selectively switch between a closed state and an open state. In this example, each contactor 30 of the plurality of contactors 30 is a normally energized normally-open contactor.

The relay board 70 includes a power supply interface 71, a plurality of opto-isolators 73 and a plurality of relays 75. A relay 75 of the plurality of relays 75 is connected between a contactor 30 of the plurality of contactors 30 and the positive connection 19 of an output of the plurality of outputs of the power supply unit 10. The relay 75 may also selectively switch between a closed state and an open state. In this example, each relay 75 of the plurality of relays 75 is a normally de-energized normally-closed relay.

A power supply circuit of an RRU 20 of the plurality of RRUs 20 is therefore formed (following retrofitting as shown in FIG. 2) between the negative connection 17 of the respective output of the plurality of outputs of the power supply unit 10, a respective contactor 30 of the plurality of contactors 30, a respective relay 75 of the plurality of relays 75, and a positive connection 19 of the respective output of the plurality of outputs of the power supply unit 10.

The first controller module 40 includes a power supply interface 41, a Universal Serial Bus (USB) interface 43, a communications interface 45, a processor 47 and memory 49. The power supply interface 41 is connected to an output of the plurality of outputs of the power supply unit 10 via the second DC to DC converter. This power supply is described in more detail below. The USB interface 43 of the first controller module 40 is suitable for power supply from the first controller module 40 to any devices connected thereto and suitable for data communications with any devices connected thereto. The communications interface 45 is an Ethernet connection interface (e.g. RJ45) and is therefore suitable for data communications with any devices connected thereto.

The second controller module 50 includes a USB interface 51, a power supply interface 53, a control signal interface 55, a processor 57 and memory 59. The USB interface 51 of the second controller module 50 connects to the USB interface 43 of the first controller module 40 via a USB cable. This USB connection provides power from the first controller module 40 to the second controller module 50 and enables data communication between the first and second controller modules 40, 50. The power supply interface 53 of the second controller module 50 is suitable for power supply from the second controller module 50 to the power supply interface 71 of the relay board 70. The first controller module 40, second controller module 50 and relay board 70 (and all components thereof) are therefore all powered by the output of the plurality of outputs of the power supply unit 10, as converted by the second DC to DC converter 60.

The control signal interface 55 of the second controller module 50 enables a control signal to be selectively communicated to one or more of the plurality of opto-isolators 73 of the relay board 70. The control signal interface 55 of the second controller module 50 is connected to the plurality of opto-isolators 73 by a ribbon cable.

A control circuit is thus formed between the output of the plurality of outputs of the power supply unit 10, the second DC to DC converter 60, the first controller module 40, the second controller module 50 and the relay board 70. The control circuit (including the first controller module 40, second controller module 50 and relay board 70, and all components thereof) have a power supply requirement that is less than the power supply of each output of the plurality of outputs of the power supply unit 10. In this example, the electrical potential difference requirement of the control circuit is less than the electrical potential difference of the power supply of the output of the plurality of outputs of the power supply unit 10. The second DC to DC converter 60 is therefore provided in the control circuit to convert the 12V power supply of the power supply unit 10 to a 5V power supply required by the control circuit. That is, the second DC to DC converter 60 is connected to the positive and negative connections 19, 17 of an output of the plurality of outputs of the power supply unit 10 and converts the 12V power supply of the power supply unit 10 to a 5V power supply required by the first controller module 40. This 5V power supply is provided to the power supply interface 41 of the first controller module 40.

The control circuit and power supply circuit of each RRU 20 are coupled by a respective opto-isolator 73 of the plurality of opto-isolators 73, which enable the control signal to be transferred from the control circuit to the power supply circuit but prevent electrical power from transferring from the power supply circuit to the control circuit.

A remote computing device 80 is also provided having a communications interface 81 and a human interface device interface 83. The communications interface 81 is an Ethernet connection interface (e.g. RJ45) and is connected to the communications interface 45 of the first controller module 40. The human interface device interface 83 enables connection to a human interface device or plurality of human interface devices (such as a keyboard, mouse, tablet, touchscreen, etc.) enabling an operative to provide instructions to the remote computing device 80, which may then be transferred via the communications interface 81 to the first controller module 40. This will be explained in more detail below.

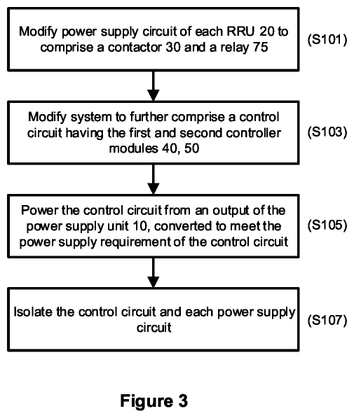

FIG. 3 is a flow diagram illustrating a method of retrofitting. In S101, a power supply circuit of each RRU 20 of the plurality of RRUs 20 is modified so as to comprise a switching unit (comprising a contactor 30 and a relay 75). In S103, a control circuit is introduced, the control circuit comprising a controller (comprising the first controller module 40 and the second controller module 50) and having a power supply requirement. In S105, the control circuit is powered by connecting the control circuit to an output of the plurality of outputs of the power supply unit 10 and converting the power supply of the output of the plurality of outputs of the power supply unit 10 so as to meet the power supply requirement of the control circuit. In S107, the control circuit is connected to each power supply circuit via a respective opto-isolator 73, enabling the control circuit to selectively transmit a control signal to a respective power supply circuit of one or more RRUs 20 of the plurality of RRUs 20.

Following retrofitting, a power supply circuit of each RRU 20 of the plurality of RRUs 20 may be selectively switched from the closed state (in which it receives the 12V power supply from the power supply unit 10) to the open state (in which it is does not receive the 12V power supply from the power supply unit 10) upon activation of the contactor 30 and relay 75 of that power supply circuit.

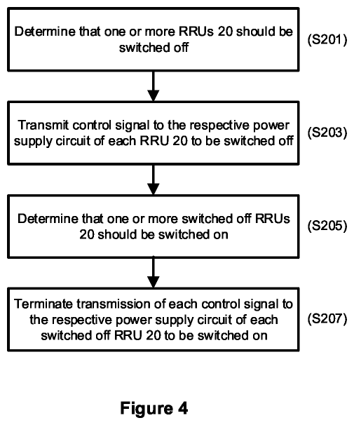

In a default state (i.e. in the absence of a control signal) of each power supply circuit, a relay 75 (being a normally de-energized normally closed relay) of the power supply circuit is in a closed state. The respective contactor 30 (being a normally energized normally open contactor) of the power supply circuit is therefore activated and in a closed state. The power supply circuit is therefore closed, and power is supplied to the respective RRU 20. The power supply circuit is therefore in a closed state by default, and may be selectively switched to the open state by operation of the control circuit (which will now be described with reference to the method illustrated in FIG. 4).

In S201, the processor 57 of the second controller module 50 determines that one or more RRUs 20 of the plurality of RRUs 20 should be switched off (i.e. powered down). This determination may be the output of, for example:
Logic (stored in memory 59) of the second controller module 50 that determines that the one or more RRUs 20 should be switched off, or
An instruction signal from the first controller module 40 (or the remote computing device 80 via the first controller module 40) to switch off the one or more RRUs 20.

In response, in S203, the second controller module 50 transmits a control signal to each opto-isolator 73 of the respective power supply circuit of each RRU 20 to be switched off. Each opto-isolator allows the control signal to be transferred from the control circuit to the respective power supply circuit of the respective RRU 20 to be switched off. On receipt of the control signal, the respective relay 75 (being a normally de-energized normally closed relay) is activated and switches from its default closed state to an open state, opening the respective power supply circuit. In response, the respective contactor 30 (being a normally-energized normally open contactor) is deactivated and opens. Provision of the control signal to the respective power supply circuit of an RRU 20 to be switched off therefore selectively switches the power supply circuit from its default closed state to an open state, preventing power supply to the respective RRU 20.

In S205, the processor 57 of the second controller module 50 determines that one or more RRUs of the plurality of RRUs that are switched off should now be switched on (i.e. powered-up). Again, this determination may be the output of, for example:
Logic (stored in memory 59) of the second controller module 50 that determines that the one or more switched off RRUs 20 should be switched on, or
An instruction signal from the first controller module 40 (or the remote computing device 80 via the first controller module 40) to switch on the one or more switched off RRUs 20.

In S207, the second controller module 50 terminates transmission of each control signal to the respective power supply circuit of each switched off RRU 20 to be switched on. On termination of the control signal, the respective relay 75 is deactivated and switches from the open state to its default closed state, closing the respective power supply circuit. In response, the respective contactor 30 is activated and closes. Termination of the control signal to the respective power supply circuit of a switched off RRU 20 therefore selectively switches the power supply circuit from the open state to its default closed state, restoring power supply to the respective RRU 20.

The second controller module 50 may locally-store (e.g. in memory 59) logic such that the energy saving equipment may autonomously control each RRU 20 of the plurality of RRUs 20 by determining that the one or more RRUs 20 of the plurality of RRUs should be switched off and transmitting a control signal to each respective power supply circuit. The second controller module 50 may obtain sensor and/or environmental data (e.g. from a sensor on the RRU 20) and the logic may be based on this sensor and/or environmental data. For example, the logic may determine that an RRU 20 should be switched off if its load is less than a threshold amount. This logic may be updated on receipt of an instruction message from the first controller module 40 (or the remote computing device 80 via the first controller module 40).

The first controller module 40 may include a human interface device interface (not shown) enabling an operative to provide instructions to the first controller module 40. Similarly, as noted above, the first controller module 40 may receive instructions input to a human interface device connected to the human interface device interface 83 of the remote computing device 80. The first controller module 40 may transmit an instruction signal to the second controller module 50 based on these instructions. The instruction signal may instruct the second controller module 50 to switch off one or more RRUs 20, update the logic of the second controller module 50 for autonomously controlling the RRUs 20, and/or cease control of the RRUs 20 (i.e. override/shutdown operation).

The energy saving equipment therefore enables power control of each network equipment of the telecommunications network by a retrofitted solution. That is, all components of the energy saving equipment can be introduced to the network equipment and be powered by the same power supply unit that provides power to the network equipment. Furthermore, the first and second controller modules (which may autonomously control the network equipment and provide a communications interface for remote power control) may be implemented on Single Board Computers (SBCs), which are low-cost, configurable and have a small form factor, which compliments a retrofitted solution. These SBCs tend to have a lower power supply requirement relative to the network equipment that they control. This is addressed in two ways. Firstly, a converter is used to convert the power supply of the power supply unit so as to satisfy the power supply requirement of the SBCs, such that no further power supply is required. Secondly, an isolator is used between each power supply circuit of the network equipment and the control circuit of the SBCs to ensure the relatively high power supply of the power supply circuit does not damage the SBCs.

The energy saving equipment has benefits over the energy saving modes currently used in telecommunications networks. These energy saving modes require the network equipment to switch from a normal mode of operation to a lower (energy saving) mode of operation. However, the network equipment still consume power in the energy saving mode of operation. In contrast, the energy saving equipment described above opens the power supply circuit and therefore prevents any power being supplied to the network equipment. The energy saving equipment therefore provides greater energy saving performance relative to these energy saving modes.

The energy saving equipment may be retrofitted to each system of a plurality of systems (each system comprising a power supply unit 10 and a plurality of RRUs 20), such that the power supply to one or more RRUs of each system may be controlled by the energy saving equipment. The controller modules of each retrofitted system may be communicatively connected (e.g. via the remote computing device 80 or by other means), such that a first set of RRUs of a first system and a second set of RRUs of a second system may be selectively controlled at the same time (e.g. contemporaneously switched off and/or contemporaneously switched on). This is particularly suitable when RRUs of the first and second systems typically cooperate when in operation.

As noted above, the default state of the relays 75 and contactors 30 is such that, in the absence of a control signal, the power supply circuit is closed. This has the benefit that the power supply circuit will operate in the same way as the unmodified version in the event the second controller module 50 loses functionality (for example, if the second controller module 50 receives an instruction signal to cease control or if the second controller module 50 is disconnected from the output of the plurality of outputs of the power supply unit 10). However, this is non-essential and any form of relay and any form of contactor may be used. Furthermore, it is non-essential that both the relay and contactor are used, and the power supply circuit may be modified so as to include one of the contactor or relay. However, the use of both the relay and contactor can be preferable as the contactor is better suited to relatively high power supply equipment and has a relatively long lifespan.

An opto-isolator 73 is used to isolate the control circuit and the power supply circuit. However, any form of isolator may be used instead, such as a transformer-based isolator or a capacitor-coupled isolator.

As noted above, the first and second controller modules 40, 50 may be implemented as SBCs, such as a Raspberry Pi or Arduino Uno. However, this is non-essential and any form of computing device may be used. Furthermore, a single controller may be provided having the functionality of the first and second controller modules 40, 50. The remote computing device 80 is also non-essential, as the controller may act autonomously, but this has the benefit of enabling remote communication with the controller (so as to update the logic on the controller, cause the controller to transmit a control signal to one or more RRUs, or cease operation).

The use of wired connections between all components in the energy saving equipment (including between the first controller module 40 and the remote computing device 80) is particularly suitable for its application to control the power supply to a plurality of RRUs as this network equipment is often contained in a faraday cage. However, the skilled person will understand that the energy saving equipment may be used to control the power supply to one or more network equipment of any type (in particular, a network equipment that may be switched from a completely powered-down state and a powered-up state and remain operational in its powered up state). For example, the network equipment may be a Base Band Unit (BBU) in a wireless wide area network.

Furthermore, the energy saving equipment may be used to control the power supply to a single network equipment.

The skilled person will understand that the values of the power supply characteristics used above are an example, and any other value may be used instead. The power supply requirement of the control circuit may differ to the power supply of an output of the plurality of outputs due to a different voltage, current, and/or other characteristic. Furthermore, it is non-essential that the power supply requirement of the control circuit is less than the power supply of an output of the plurality of outputs of the power supply unit. The power supply requirement of the control circuit may be more than the power supplied by the output of the plurality of outputs of the power supply unit, such that the isolator prevents the relative high power control circuit from damaging the network equipment.

The description above describes a method of retrofitting network equipment with an energy saving solution. However, the skilled person will understand that the energy saving solution may be implemented as part of the network equipment by initial design (that is, a system is produced by manufacture or assembly comprising the network equipment, power supply unit and the energy saving solution).

The skilled person will understand that any combination of features is possible within the scope of the disclosure, as claimed.

1. A method of retrofitting a system, the system being in a telecommunications network and comprising a network equipment being one of a Remote Radio Unit (RRU) or Base Band Unit (BBU) a power supply unit, and a power supply circuit, wherein the power supply circuit is provided between a first output of a plurality of outputs of the power supply unit and the network equipment, the method comprising:
modifying the power supply circuit to comprise a switching unit configured to switch between an open state and a closed state;
modifying the system to include a control circuit, wherein the control circuit comprises a controller having a power supply requirement;
powering the control circuit by:
connecting the control circuit to a second output of the plurality of outputs of the power supply unit, and
converting a power supply of the second output of the plurality of outputs of the power supply unit to meet the power supply requirement of the controller;
isolating the control circuit and the power supply circuit using an isolator; and
configuring the controller to, in response to a command to control the switching unit, control the switching unit to cause the controlled switching unit to switch between the open state and the closed state.

2. The method as claimed in claim 1, wherein:
the switching unit comprises a first switch and a second switch, the first switch and the second switch each being configured to switch between an open state and a closed state, and
the controller is configured to, in response to the command to control the switching unit, control the first switch and the second switch of the switching unit to cause the controlled first switch and the second switch of the switching unit to switch between the open state and the closed state.

3. The method as claimed in claim 1, wherein the system comprises a plurality of network equipment and a plurality of power supply circuits, wherein each of the plurality of network equipment is one of a Unit, RRU or a BBU and each the plurality of power supply circuits is provided between a respective output of the plurality of outputs of the power supply unit and a respective network equipment of the plurality of network equipment, the method further comprising:
modifying each the plurality of power supply circuits to comprise a respective switching unit configured to switch between an open state and a closed state;
isolating the control circuit and each power supply circuit of the plurality of power supply circuits using a respective isolator; and
configuring the controller to, in response to a command to control one or more of the plurality of switching units, selectively control the one or more of the plurality of switching units in the command to cause the controlled one or more of the plurality of switching units to switch between the open state and the closed state.

4. The method as claimed in claim 3, wherein:
each respective switching unit comprises a first switch and a second switch, the first switch and the second switch of each respective switching unit being configured to switch between an open state and a closed state, and
configuring the controller to, in response to the command to control one or more of the plurality of switching units, selectively control the first switch and the second switch of the one or more of the plurality of switching units in the command to cause the controlled first switch and the second switch of the one or more of the plurality of switching units to switch between the open state and the closed state.

5. The method as claimed in claim 3, further comprising
connecting the controller to a remote computing device, wherein the controller is configured to receive, from the remote computing device, one or more of:
the command to control the switching unit or the one or more of the plurality of switching units,
an instruction to update command generation logic, or
an instruction to cease operation.

6. A method of retrofitting a plurality of systems, each system being retrofitted according to the method of claim 1 wherein the respective controller of each system is configured, in response to the command to control the respective switching unit or one or more of the plurality of respective switching units, to:
control the respective switching unit to cause the controlled respective switching unit to switch between the open state and the closed state,
control the first switch and the second switch of the respective switching unit to cause the activated first switch and the second switch switches of the respective switching unit to switch between the open state and the closed state,
selectively control the one or more of the plurality of respective switching units in the command to cause the activated one or more of the plurality of respective switching units to switch between the open state and the closed state, or
selectively control the first switch and the second switch of the one or more of the plurality of respective switching units in the command to cause the activated first switch and the second switch of the one or more of the plurality of respective switching units to switch between the open state and the closed state.

7. The method as claimed in claim 6, further comprising:
connecting each respective controller of the plurality of systems to a remote computing device, wherein each respective controller is configured to receive, from the remote computing device, one or more of:
the command to control the respective switching unit or the one or more of the plurality of respective switching units,
an instruction to update command generation logic, or
an instruction to cease operation.

8. A system in a telecommunications network, the system comprising:
a network equipment being one of a Remote Radio Unit (RRU) or a Base Band Unit BBU;
a power supply unit;
a power supply circuit, wherein the power supply circuit is provided between a first output of a plurality of outputs of the power supply unit and the network equipment, the power supply circuit comprising a switching unit configured to switch between an open state and a closed state;
a control circuit comprising a controller having a power supply requirement, wherein the control circuit is connected to a second output of the plurality of outputs of the power supply;
a converter for converting the power supply of the second output of the plurality of outputs of the power supply unit to meet the power supply requirement of the control circuit; and
an isolator configured to isolate the control circuit and the power supply circuit,
wherein, in response to a command to control the switching unit, the controller controls the switching unit causing the controlled switching unit to switch between the open state and the closed state.

9. The system as claimed in claim 8, wherein the switching unit comprises a first switch and a second switch, the first switch and the second switch each being configured to switch between an open state and a closed state, and, in response to the command to control the switching unit, the controller controls the first switch and the second switch of the switching unit to cause the controlled first switch and the second switch of the switching unit to switch between the open state and the closed state.

10. The system as claimed in claim 8 wherein:
the network equipment is one of a plurality of network equipment, each being one of a RRU, or a BBU,
the power supply circuit is one of a plurality of power supply circuits, wherein each of the plurality of power supply circuits is provided between a respective output of the plurality of outputs of the power supply unit and a respective network equipment of the plurality of network equipment, each of the plurality of power supply circuits comprising a respective switching unit,
the isolator is one of a plurality of isolators each isolating the control circuit from a respective power supply circuit of the plurality of power supply circuits,
wherein, in response to the command to control one or more of the plurality of switching units, the controller selectively controls the one or more of the plurality of switching units in the command causing the controlled one or more of the plurality of switching units to switch between the open state and the closed state.

11. The system as claimed in claim 10, wherein:
each respective switching unit comprises a first switch and a second switch, the first switch and the second switch of each respective switching unit being configured to switch between an open state and a closed state, and, in response to the command to control one or more of the plurality of switching units, the controller selectively controls the first switch and the second switch of the one or more of the plurality of switching units in the command to cause the controlled first switch and the second switch of the one or more of the plurality of switching units to switch between the open state and the closed state.

12. The system as claimed in claim 8, wherein the controller is configured to receive a message including one or more of:
the command to control the switching unit or the one or more of the plurality of switching units,
an instruction to update command generation logic, or
an instruction to cease operation.

13. A plurality of systems, each system of the plurality of systems being the system as claimed in claim 8 wherein, in response to the command to control the respective switching unit or one or more of the plurality of respective switching units, the respective controller of each system:
controls the respective switching unit causing the controlled respective switching unit to switch between the open state and the closed state,
controls the first switch and the second switch of the respective switching unit causing the controlled first switch and the second switch of the respective switching unit to switch between the open state and the closed state,
selectively controls the one or more of the plurality of respective switching units in the command causing the controlled one or more of the plurality of respective switching units to switch between the open state and the closed state, or
selectively controls the first switch and the second switch of the one or more of the plurality of respective switching units in the command to cause the controlled first switch and the second switch of the one or more of the plurality of respective switching units to switch between the open state and the closed state.

14. The plurality of systems as claimed in claim 13, wherein each respective controller of the plurality of systems is configured to receive a message including one or more of:
the command to control the respective switching unit or the one or more of the plurality of respective switching units,
an instruction to update command generation logic, or
an instruction to cease operation.

15. The system as claimed in claim 12, further comprising a remote computing device, wherein the controller receives the message from the remote computing device.

16. The system as claimed in claim 12, wherein the controller comprises a human interface device, and the controller receives the message from the human interface device.

17. The system as claimed in claim 12, as wherein the controller comprises a first controller module and a second controller module, wherein:
the first controller module is configured to receive the message, and
the second controller module is configured to, in response to the command to control the respective switching unit
control the respective switching unit causing the controlled respective switching unit to switch between the open state and the closed state,
control the first switch and the second switch of the respective switching unit causing the controlled first switch and the second switch of the respective switching unit to switch between the open state and the closed state,
selectively control the one or more of the plurality of respective switching units in the command causing the controlled one or more of the plurality of respective switching units to switch between the open state and the closed state, or
selectively control the first switch and the second switch of the one or more of the plurality of respective switching units in the command to cause the controlled first switch and the second switch of the one or more of the plurality of respective switching units to switch between the open state and the closed state.

18. The system as claimed in claim 17, further comprising a remote computing device, wherein the controller receives the message from the remote computing device, and wherein the first controller module comprises a communications interface for receiving the message from the remote computing device and is configured to cause the second controller module to implement the command or instruction included in the message.

19. The system as claimed in claim 17, wherein the controller comprises a human interface device, and the controller receives the message from the human interface device, and wherein the first controller module comprises a human interface device interface for receiving the message from the human interface device, and the first controller module is configured to cause the second controller module to implement the command or instruction included in the message.

20. The system as claimed in claim 8, wherein the controller, comprises a processor configured to implement logic for generating the command.

21. The system as claimed in claim 8, wherein the switching unit is in a closed state by default.

22. The system as claimed in claim 8, wherein the switching unit comprises one or more of: a contactor or a relay.

23. (canceled)

24. The system as claimed in claim 8, wherein the controller is a Single Board Computer (SBC).

25. The system as claimed in claim 17, wherein the first controller module controller module a Single Board Computer (SBC).
